(19) United States
(12) Patent Application Publication
(10) Pub. No.: US 2018/0093522 A1
(43) Pub. Date: Apr. 5, 2018

(54) School Supplies Storage System

(71) Applicant: Desirée McGee - Greene, Sun Prairie, WI (US)

(72) Inventor: Desirée McGee - Greene, Sun Prairie, WI (US)

(21) Appl. No.: 15/286,240

(22) Filed: Oct. 5, 2016

(51) Int. Cl. B42F 7/06; A45C 11/34

(52) U.S. Cl. CPC B42F 7/06; A45C 11/34

(57) ABSTRACT

A school supplies storage system for elementary education includes a plurality of writing utensils and a plurality of books. A storage unit is selectively positioned between a folded position and an unfolded position. The storage unit forms a book case when the storage unit is in the folded position. The storage unit has a plurality of pockets. Each of the writing utensils is positioned in selected ones of the pockets. Thus, each of the writing utensils is accessible for writing. The storage unit includes a name plate to identify a user of the storage unit.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIE THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention.

### (2) Description of Related Art Including Information Disclosed Under 37 CFR 1.97 and 1.98.

The disclosure and prior art relates to storage devices and more particularly pertains to a new storage device for organizing items in an elementary educational environment.

### (h) BRIEF SUMMARY OF THE INVENTION

An embodiment of the disclosure meets the needs presented above by generally comprising a plurality of writing utensils and a plurality of books. A storage unit is selectively positioned between a folded position and an unfolded position. The storage unit forms a book case when the storage unit is in the folded position. The storage unit has a plurality of pockets. Each of the writing utensils is positioned in selected ones of the pockets. Thus, each of the writing utensils is accessible for writing. The storage unit includes a name plate to identify a user of the storage unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a school supplies storage system according to an embodiment of the disclosure.

FIG. 2 is a back view of an embodiment of the disclosure.

FIG. 3 is a left side view of an embodiment of the disclosure.

FIG. 4 is a front view of an embodiment of the disclosure.

FIG. 5 is a right side view of an embodiment of the disclosure.

FIG. 6 is a perspective view of an embodiment of the disclosure in an unfolded position.

FIG. 7 is a perspective in-use view of an embodiment of the disclosure.

FIG. 8 is a perspective view of an alternative embodiment of the disclosure.

### (j) DETAILED DESCRIPTION OF THE INVENTION

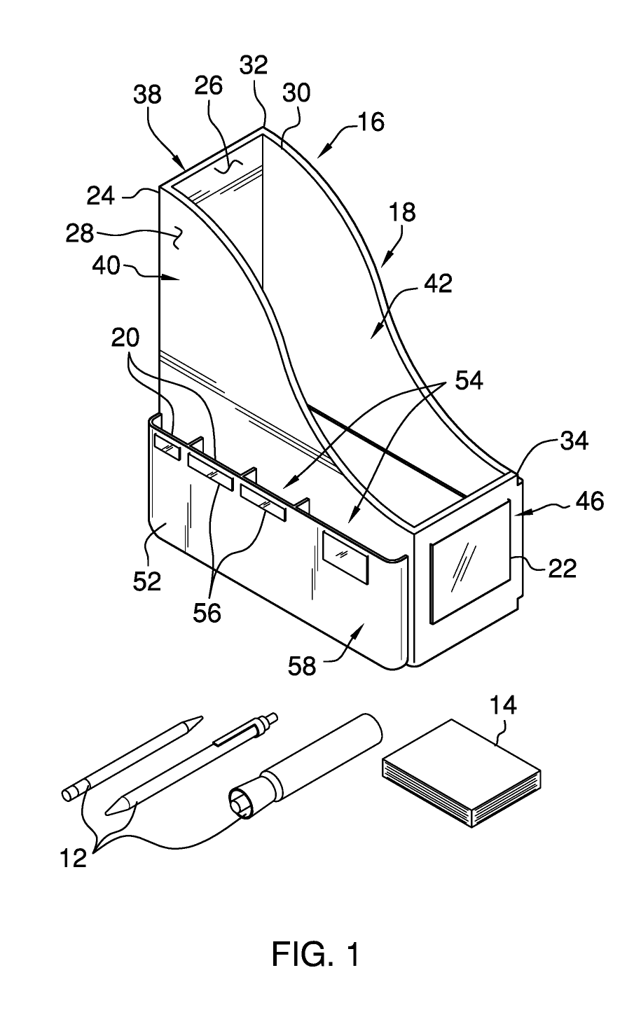

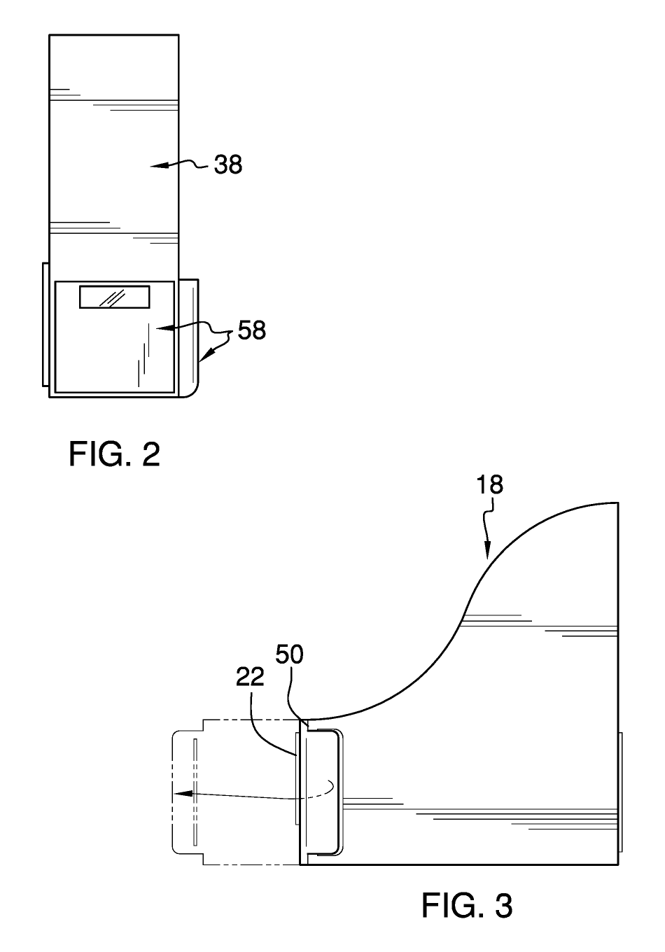

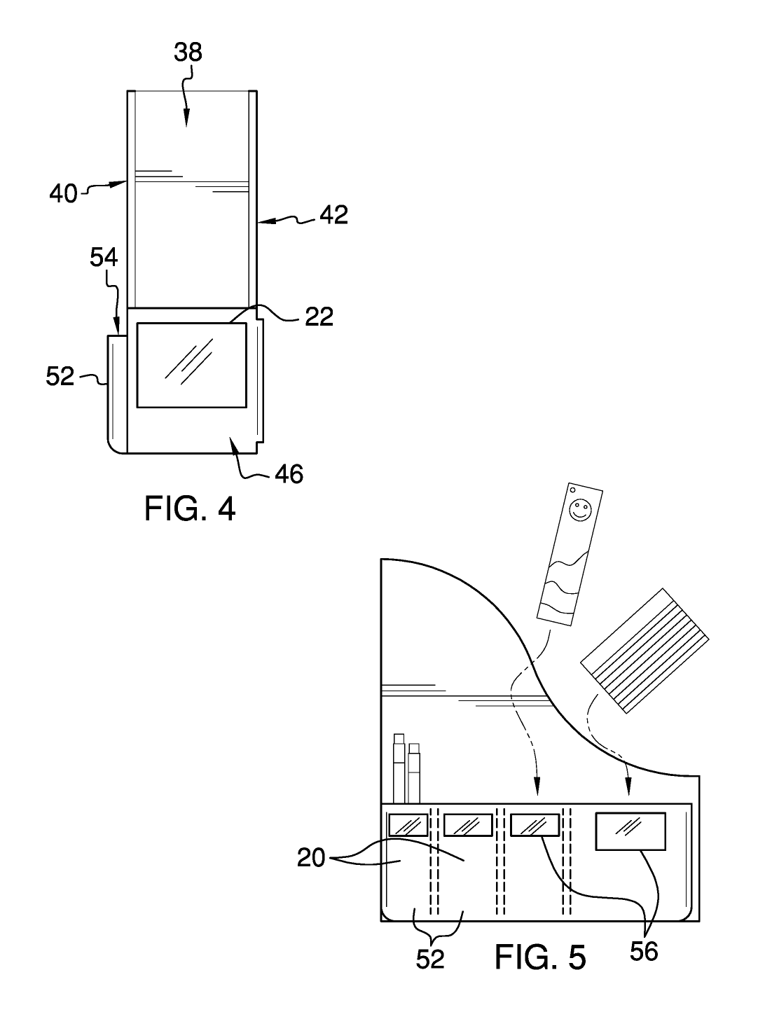

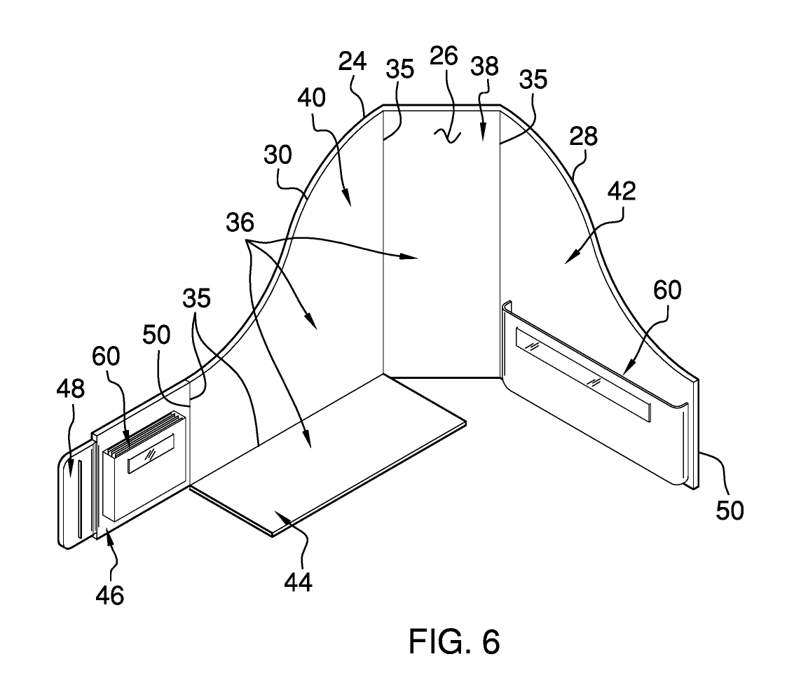

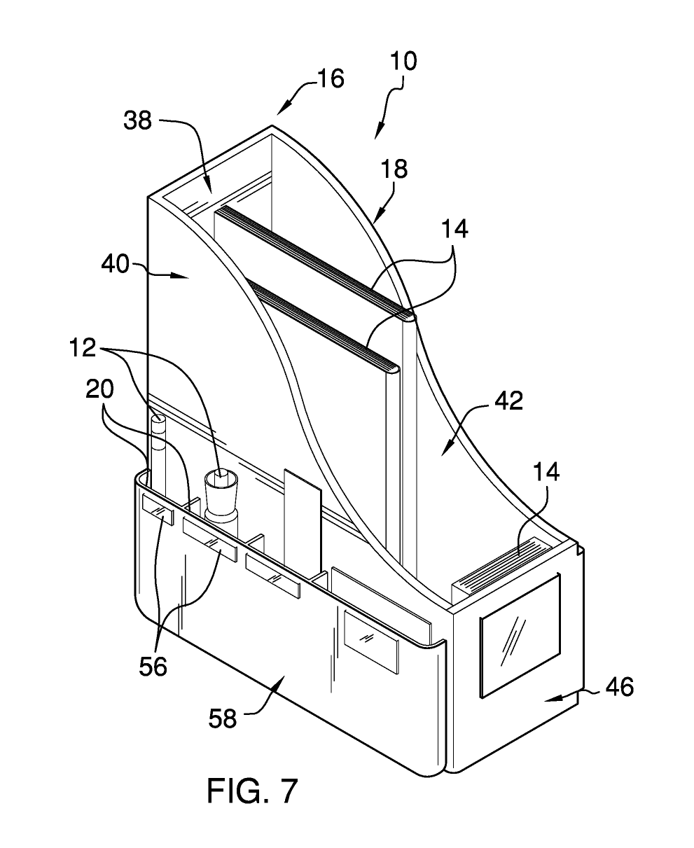

With reference now to the drawings, and in particular to FIGS. 1 through 8 thereof, a new storage device embodying the principles and concepts of an embodiment of the disclosure and generally designated by the reference numeral 10 will be described.

As best illustrated in FIGS. 1 through 8, the school supplies storage system 10 generally comprises a plurality of writing utensils 12. The plurality of writing utensils 12 may include markers, pencils, colored pencils and other writing utensils 12 found in an elementary education environment. A plurality of books 14 is provided. The plurality of books 14 may include text books 14, note books 14, sticky pads and other books 14 found in an elementary education environment.

A storage unit 16 is provided. The storage unit 16 is selectively positioned between a folded position and an unfolded position. The storage unit 16 forms a book case 18 when the storage unit 16 is in the folded position. Each of the books 14 is positioned in the book case 18. Each of the books 14 is vertically oriented having a binding of each of the books 14 being exposed. Thus, each of the plurality of books 14 may be identified by title.

The storage unit 16 has a plurality of pockets 20. Each of the writing utensils 12 is positioned in selected ones of the pockets 20. Thus, each of the writing utensils 12 is accessible for writing. The storage unit 16 includes a name plate 22. The name plate 22 identifies a user of the storage unit 16.

The storage unit 16 comprises a panel 24 that has a first surface 26, a second surface 28 and a peripheral edge 30 extending therebetween. The peripheral edge 30 has a top side 32 and a bottom side 34. The panel 24 has a plurality of bends 35 thereon. Each of the bends 35 extends between the top side 32 and the bottom side 34. Moreover, the bends 35 are spaced apart from each other and are distributed on the panel 24.

The bends 35 define a plurality of portions 36 of the panel 24. Each of the portions 36 may be manipulated between the folded position and the unfolded position. The plurality of portions 36 includes a back portion 38, a first side portion 40, a second side portion 42, a bottom portion 44, a front portion 46 and a tab portion 48. Each of the first side portion 40 and the second side portion 42 has a distal edge 50 with respect to the back portion 38.

Each of the first side portion 40 and the second side portion 42 is oriented perpendicular to the back portion 38 when the panel 24 is in the folded position. The bottom portion 44 is oriented perpendicular to the first side portion 40 and the second side portion 42. Moreover, the bottom portion 44 extends between the bottom side 34 corresponding to each of the first side portion 40 and the second side portion 42 when the panel 24 is in the folded position. The top side 32 corresponding to each of the first side portion 40 and the second side portion 42 is arcuate between the back portion 38 and the corresponding distal edge 50. Moreover, the top side 32 corresponding to each of the first side portion 40 and the second side portion 42 defines a sine curve.

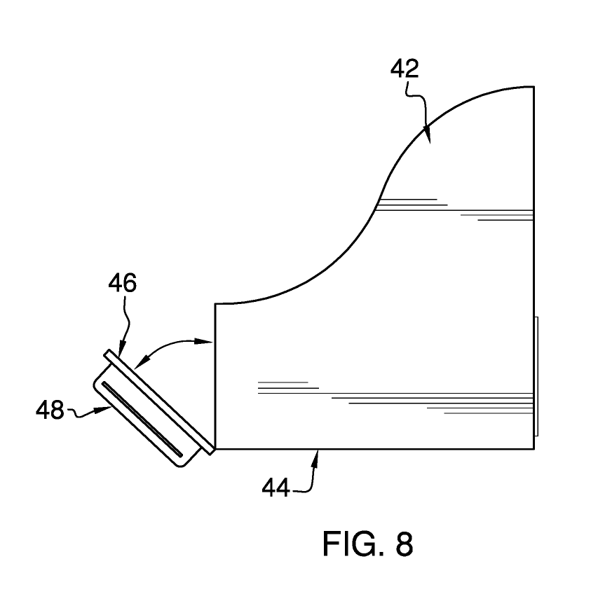

The front portion 46 extends between the distal edge 50 of each of the first side portion 40 and the second side portion 42 when the panel 24 is in the folded position. The tab portion 48 frictionally engages the second surface 28 corresponding to the second side portion 42 when the panel 24 is positioned in the folded position. Thus, the tab portion 48 retains the panel 24 in the folded position. The tab portion 48 may include a lock or the like. The lock may removably engage the second side portion 42. In an alternative embodiment 51 as shown in FIG. 8, the front portion 46 may extend forwardly from the bottom portion 44. Thus, the front portion 46 may hinge upwardly and downwardly to extend between the first 40 and second 42 side portions.

Each of the pockets 20 has a front side 52 and each of the pockets 20 is coupled to the panel 24. The front side 52 is spaced from the panel 24 to define an opening 54 in each of the pockets 20. Each of the pockets 20 has a window 56 extending through the front side 52. The window 56 facilitates contents of the pockets 20 to be visible.

The plurality of pockets 20 includes a set of outer pockets 58 and a set of inner pockets 60. Each of the outer pockets 58 is positioned on the second surface 28 of an associated one of the first side portion 40, the front portion 46 and the back portion 38. Each of the inner pockets 60 is positioned on the first surface 26 of an associated one of the first side portion 40 and the front portion 46. The name plate 22 is positioned on the second surface 28 corresponding to the front portion 46. Moreover, the name plate 22 may comprise a translucent pocket or the like.

In use, the panel 24 is manipulated into the folded position to form the book case 18. The book case 18 is positioned to be accessible to children in an environmental education environment. The books 14 are positioned in the book case 18. The writing utensils 12 are positioned in selected pockets 20. Additionally, papers and other objects are positioned in selected pockets 20. The pockets 20 facilitate the writing utensils 12 and papers to be organized with respect to ownership of the book case 18. Thus, the book case 18 facilitates an organized environmental education environment.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A school supplies storage system comprising:
a plurality of writing utensils;
a plurality of books; a storage unit being selectively positioned between a folded position and an unfolded position, said storage unit forming a book case when said storage unit is in said folded position, each of said books being positioned in said book case such that each of said books is vertically oriented having a binding of each of said books being exposed wherein said plurality of books is configured to be identified by title, said storage unit having a plurality of pockets, each of said writing utensils being positioned in selected ones of said pockets wherein each of said writing utensils is configured to be accessible for writing, said storage unit including a name plate wherein said name plate is configured to identify a user of said storage unit;
wherein said storage unit comprises a panel having a first surface, a second surface and a peripheral edge extending therebetween, said peripheral edge having a top side and a bottom side, said panel having a plurality of first bends thereon, each of said first bends extending between said top side and said bottom side, said first bends being spaced apart from each other and being distributed on said panel, said first bends defines defining a plurality of upper portions of said panel wherein each of said upper portions is configured to be manipulated between said folded position and said unfolded position, said plurality of upper portions includes a back portion, a first side portion, a second side portion, a front portion and a tab portion, each of said first side portion and said second side portion having a distal edge with respect to said back portion; and
wherein said plurality of pockets includes a set of outer pockets and a set of inner pockets, each of said outer pockets being positioned on said second surface of an associated one of said first side portion and said back portion, each of said inner pockets being positioned on said first surface of an associated one of said first side portion and said front portion.

2. (canceled)

3. (canceled)

4. The system according to claim 1, wherein each of said first side portion and said second side portion is oriented perpendicular to said back portion when said panel is in said folded position, said panel including a bottom bend, said bottom bend defining a bottom portion, said bottom portion being oriented perpendicular to said first side portion and said second side portion having said bottom portion extending between said bottom side corresponding to each of said first side portion and said second side portion when said panel is in said folded position.

5. The system according to claim 1, wherein said front portion extends between said distal edge of each of said first side portion and said second side portion when said panel is in said folded position, said tab portion engaging said second surface corresponding to said second side portion when said panel is positioned in said folded position such that said tab retains said panel in said folded position.

6. The system according to claim 1, wherein each of said pockets has a front side, each of said pockets being coupled to said panel having said front side being spaced from said panel to define an opening in each of said pockets, each of said pockets having a window extending through said front side.

7. (canceled)

8. A school supplies storage system comprising:
a plurality of writing utensils;
a plurality of books; and
a storage unit being selectively positioned between a folded position and an unfolded position, said storage unit forming a book case when said storage unit is in said folded position, each of said books being positioned in said book case such that each of said books is vertically oriented having a binding of each of said books being exposed wherein said plurality of books is configured to be identified by title, said storage unit having a plurality of pockets, each of said writing utensils being positioned in selected ones of said pockets wherein each of said writing utensils is configured to be accessible for writing, said storage unit including a name plate wherein said name plate is configured to identify a user of said storage unit, said storage unit comprising:
a panel having a first surface, a second surface and a peripheral edge extending therebetween, said peripheral edge having a top side and a bottom side, said panel having a plurality of first bends thereon, each of said first bends extending between said top side and said bottom side, said first bends being spaced apart from each other and being distributed on said panel, said first bends defining a plurality of upper portions of said panel wherein each of said upper portions is configured to be manipulated between said folded position and said unfolded position, said plurality of upper portions including a back portion, a first side portion, a second side portion, a front portion and a tab portion, each of said first side portion and said second side portion having a distal edge with respect to said back portion, each of said first side portion and said second side portion being oriented perpendicular to said back portion when said panel is in said folded position, said panel including a bottom bend, said bottom bend defining a bottom portion, said bottom portion being oriented perpendicular to said first side portion and said second side portion having said bottom portion extending between said bottom side corresponding to each of said first side portion and said second side portion when said panel is in said folded position, said front portion extending between said distal edge of each of said first side portion and said second side portion when said panel is in said folded position, said tab portion engaging said second surface corresponding to said second side portion when said panel is positioned in said folded position such that said tab retains said panel in said folded position,
each of said pockets having front side, each of said pockets being coupled to said panel having said front side being spaced from said panel to define an opening in each of said pockets, each of said pockets having a window extending through said front side, said plurality of pockets including a set of outer pockets and a set of inner pockets, each of said outer pockets being positioned on said second surface of an associated one of said first side portion and said back portion, each of said inner pockets being positioned on said first surface of an associated one of said first side portion and front portion.
